(19) United States
(12) Patent Application Publication
(10) Pub. No.: US 2025/0283637 A1
(43) Pub. Date: Sep. 11, 2025

(54) SYSTEM AND METHOD FOR VISUAL DETECTION AND MEASUREMENT OF HELIOSTAT MIRROR SOILING

(71) Applicant: Heliogen Holdings, Inc., Pasadena, CA (US)

(72) Inventors: Alexander Anthony Sonn, San Gabriel, CA (US); Anthony Matthew Roy, Los Angeles, CA (US); Benjamin Cheung Liu, Arcadia, CA (US); Brian Edmond Brewington, Superior, CO (US); Maximilian Ted Zavodny, Coeur d'Alene, ID (US); Nicholas Gang Dou, Monrovia, CA (US)

(21) Appl. No.: 19/069,565

(22) Filed: Mar. 4, 2025

Related U.S. Application Data
(60) Provisional application No. 63/562,435, filed on Mar. 7, 2024.

(51) Int. Cl. F24S 40/90; F24S 23/70; H04N 23/90

(52) U.S. Cl. CPC F24S 40/90; F24S 23/70; H04N 23/90; F24S 2023/876

(57) ABSTRACT

A device may include one or more cameras arranged relative to the heliostat field so that heliostats in the heliostat field are in a field of view of the one or more cameras, the one or more cameras operable to capture an image of the heliostat field. A device may include a processor configured to: receive the captured image, detect in the captured image one or more soiled heliostat mirrors in the heliostat field; and determine a level of soiling of said one or more soiled heliostat mirrors in the heliostat field.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to heliostats, and more particularly to a system and method for visual detection and measurement of heliostat mirror soiling.

### Description of the Related Art

Heliostats are controlled to track the sun and focus the solar energy on a receiver. Tracking control may include the use of cameras that take images of the heliostats. However, heliostat mirrors can become soiled over time and in need of cleaning, which can reduce the efficiency of the system.

### SUMMARY

In accordance with one aspect of the disclosure, a system is provided for visual detection and measurement of heliostat mirror soiling. In one implementation, images of heliostats in a heliostat field captured by camera(s) are processed to detect soiling on the mirrors and to determine a level of soiling on the heliostat mirrors. In one example, the detected soiling and determined level of soiling can be used to identify heliostat mirrors in the heliostat field in need of cleaning. Additionally or alternatively, the detected soiling and determined level of soiling can be used to adjust an orientation of one or more additional heliostat mirrors to direct sunlight toward a receiver of a concentrated solar power (CSP) system to provide a desired (e.g., predetermined) amount of solar flux to the receiver (e.g., to make up for a reduced solar flux provided by the soiled heliostat mirrors).

In some aspects, the techniques described herein relate to a system for operating a heliostat field of a concentrated solar power (CSP) plant, including: one or more cameras arranged relative to the heliostat field so that heliostats in the heliostat field are in a field of view of the one or more cameras, the one or more cameras operable to capture an image of the heliostat field; and a processor configured to: receive the captured image, detect in the captured image one or more soiled heliostat mirrors in the heliostat field; and determine a level of soiling of said one or more soiled heliostat mirrors in the heliostat field.

In some aspects, the techniques described herein relate to a system, wherein the processor is further configured to determine a reduction in energy output from said one or more soiled heliostat mirrors based on the determined level of soiling of said one or more heliostat mirrors.

In some aspects, the techniques described herein relate to a system, wherein the processor is further configured to determine a number of additional heliostat mirrors required to provide an amount of energy output equal to the reduction in energy output from said one or more soiled heliostat mirrors.

In some aspects, the techniques described herein relate to a system, wherein the processor is further configured to adjust an orientation of the number of additional heliostat mirrors to focus sunlight on the receiver of the CSP plant to provide said amount of energy output to the receiver.

In some aspects, the techniques described herein relate to a system, wherein detecting the one or more soiled heliostat mirrors includes identifying shadows on heliostat mirrors in the captured image.

In some aspects, the techniques described herein relate to a system, wherein determining the level of soiling includes using a look-up table that correlates an image of a shadow on a heliostat mirror in the captured image with a level of soiling.

In some aspects, the techniques described herein relate to a system, wherein correlating the image of the shadow with the level of soiling includes correlating a sharpness of one or more edges of the shadow with the level of soiling.

In some aspects, the techniques described herein relate to a system, wherein the processor is further configured to identify one or more soiled heliostat mirrors in the heliostat field requiring cleaning.

In some aspects, the techniques described herein relate to a system, wherein identifying the one or more soiled heliostat mirrors requiring cleaning includes identifying soiled heliostat mirrors with a level of soiling exceeding a threshold amount of soiling.

In some aspects, the techniques described herein relate to a method operating a heliostat field of a concentrated solar power (CSP) plant, including: receiving with a computer processor an image of the heliostat field captured by one or more cameras; detecting with the computer processor one or more soiled heliostat mirrors in the heliostat field from the image captured by the one or more cameras; and determining with the computer processor a level of soiling of said one or more soiled heliostat mirrors in the heliostat field.

In some aspects, the techniques described herein relate to a method, further including determining with the computer processor a reduction in energy output from said one or more soiled heliostat mirrors based on the determined level of soiling of said one or more heliostat mirrors.

In some aspects, the techniques described herein relate to a method, further including determining with the computer processor a number of additional heliostat mirrors required to provide an amount of energy output equal to the reduction in energy output from said one or more soiled heliostat mirrors.

In some aspects, the techniques described herein relate to a method, further including adjusting with the computer processor an orientation of the number of additional heliostat mirrors to focus sunlight on the receiver of the CSP plant to provide said amount of energy output to the receiver.

In some aspects, the techniques described herein relate to a method, wherein detecting the one or more soiled heliostat mirrors includes identifying shadows on heliostat mirrors in the captured image.

In some aspects, the techniques described herein relate to a method, wherein determining the level of soiling includes using a look-up table that correlates an image of a shadow on a heliostat mirror in the captured image with a level of soiling.

In some aspects, the techniques described herein relate to a method, wherein correlating the image of the shadow with the level of soiling includes correlating a sharpness of one or more edges of the shadow with the level of soiling.

In some aspects, the techniques described herein relate to a method, further including identifying with the computer processor one or more soiled heliostat mirrors in the heliostat field requiring cleaning.

In some aspects, the techniques described herein relate to a method, wherein identifying the one or more soiled heliostat mirrors requiring cleaning includes identifying soiled heliostat mirrors with a level of soiling exceeding a threshold amount of soiling.

In some aspects, the techniques described herein relate to a computer executable code stored in a computer readable memory, that when executed by a computer processor is configured to cause the computer processor to: receive an image of a heliostat field captured by one or more cameras; detect one or more soiled heliostat mirrors in the heliostat field from the image captured by the one or more cameras; and determine a level of soiling of said one or more soiled heliostat mirrors in the heliostat field.

In some aspects, the techniques described herein relate to a code, wherein when executed by the computer processor, the computer executable code causes the computer processor to determine a reduction in energy output from said one or more soiled heliostat mirrors based on the determined level of soiling of said one or more heliostat mirrors.

In some aspects, the techniques described herein relate to a code, wherein when executed by the computer processor, the computer executable code causes the computer processor to determine a number of additional heliostat mirrors required to provide an amount of energy output equal to the reduction in energy output from said one or more soiled heliostat mirrors.

In some aspects, the techniques described herein relate to a code, wherein when executed by the computer processor, the computer executable code causes the computer processor to adjust an orientation of the number of additional heliostat mirrors to focus sunlight on a receiver of a concentrated solar power plant to provide said amount of energy output to the receiver.

In some aspects, the techniques described herein relate to a code, when executed by the computer processor, the computer executable code causes the computer processor to detect the one or more soiled heliostat mirrors by identifying shadows on heliostat mirrors in the captured image.

In some aspects, the techniques described herein relate to a code, when executed by the computer processor, the computer executable code causes the computer processor to determine the level of soiling using a look-up table to correlate an image of a shadow on a heliostat mirror in the captured image with a level of soiling.

In some aspects, the techniques described herein relate to a code, when executed by the computer processor, the computer executable code causes the computer processor to correlate the image of the shadow with the level of soiling by correlating a sharpness of one or more edges of the shadow with the level of soiling.

In some aspects, the techniques described herein relate to a code, when executed by the computer processor, the computer executable code causes the computer processor to identify one or more soiled heliostat mirrors in the heliostat field requiring cleaning.

In some aspects, the techniques described herein relate to a code, when executed by the computer processor, the computer executable code causes the computer processor to identify the one or more soiled heliostat mirrors requiring cleaning by identifying soiled heliostat mirrors with a level of soiling exceeding a threshold amount of soiling.

In some aspects, the techniques described herein relate to a method for visual detection and measurement of soiling of heliostats in a heliostat field of a concentrated solar power (CSP) plant, including: illuminating a heliostat mirror from a side; visually detecting soling on the heliostat mirror; determining a level of soiling on the heliostat mirror; and determining that the heliostat mirror requires cleaning based on the determined level of soiling exceeding a threshold amount.

In some aspects, the techniques described herein relate to a method, wherein illuminating the heliostat mirror includes positioning a maintenance cart proximate the heliostat mirror and operating a lighting device.

### BRIEF DESCRIPTION OF THE DRAWINGS

FIG. 1 is a schematic elevation view of a concentrated solar power (CSP) system with an array of heliostats and a receiver.

FIG. 2 is a front side view of the receiver.

FIG. 3 is a schematic perspective view of the array of heliostats and receiver of the concentrated solar power (CSP) system.

FIG. 4 is an image of heliostats captured by a camera of the CSP system.

FIG. 5 is a partial image of a heliostat field.

FIG. 6 is a partial image of a heliostat field.

FIG. 7 is an image of a heliostat with mirror soiling and a heliostat with no mirror soiling.

FIG. 8 is a schematic block diagram illustrating a processing system for the CSP system.

FIG. 9 is a flowchart of a process or method for controlling heliostats in the CSP system based on visual detection and measurement of heliostat mirror soiling.

FIG. 10 is a flowchart of a process or method for identifying heliostats in the CSP system for cleaning based on visual detection and measurement of heliostat mirror soiling.

FIG. 11 is a flowchart of a process or method for identifying heliostats in the CSP system for cleaning based on visual detection and measurement of heliostat mirror soiling.

### DETAILED DESCRIPTION

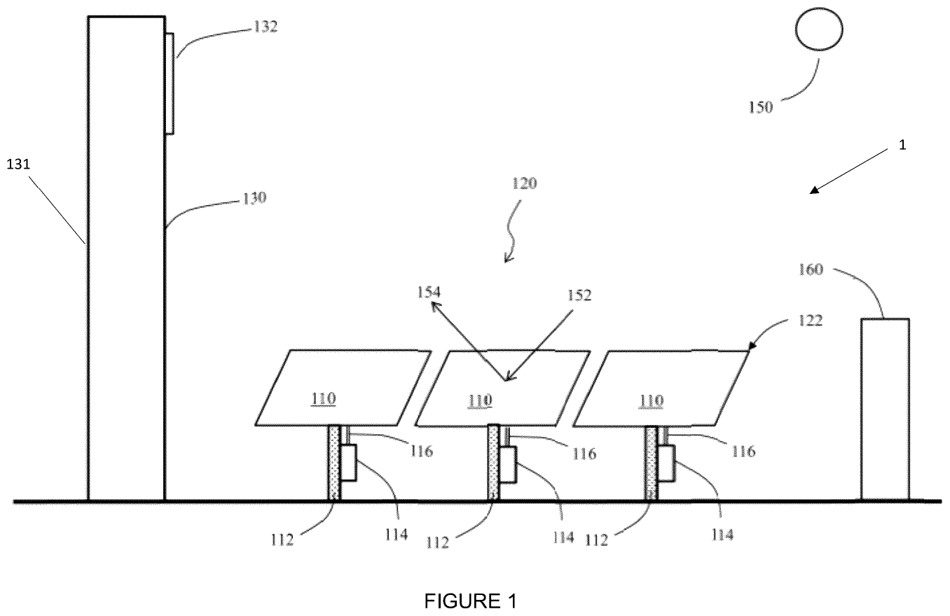

FIG. 1 shows an elevation view of a heliostat array or field 120 and a receiver 130 of a concentrated solar power (CSP) system or plant 1. The receiver 130 can include a tower 131 and an aperture 132. The heliostat array or field 120 includes one or more (e.g., multiple) heliostats 122 that are distributed in two dimensions in proximity to the receiver 130. Each heliostat 122 includes a mirror 110 pivotably coupled to a frame or stanchion 112 affixed to (e.g., disposed on, embedded in) the ground and/or to other heliostats. Each heliostat 122 further includes a tracking controller 114 operable to determine the proper orientation of its associated mirror 110 throughout the day. A mirror 110 is properly oriented when the incoming light 152 from the sun 150 is reflected to (e.g., concentrated on) the solar thermal receiver 130, specifically the receiver aperture 132. In another implementation, all of the heliostats 122 in the heliostat array or field 120 share the same tracking controller that determines the proper orientation of the mirrors 110 of the heliostats 122 throughout the day. If the actual orientation of the mirror 110 differs from the proper orientation at that instant, the tracking controller 114 energizes actuator(s) 116 that drive the mirror 110 to the proper orientation (e.g., elevation angle and/or azimuth angle of the mirror 110). Determining the proper orientation of the mirror 110 for each heliostat 122 includes estimating the normal angle of the heliostat 122 (e.g., of the mirror 110)—that is the perpendicular angle to the mirror 110 of the heliostat 122.

The solar tracking system further includes a controller 160 (e.g., a time-division multiplexing (TDM) power controller) coupled to the tracking controller 114 and actuators 116 for each of the heliostats 122. In particular, the controller 160 provides power to each of the tracking controller 114 as well as the power to energize the associated actuators 116 that aim the associated mirror 110 (e.g., toward the aperture 132).

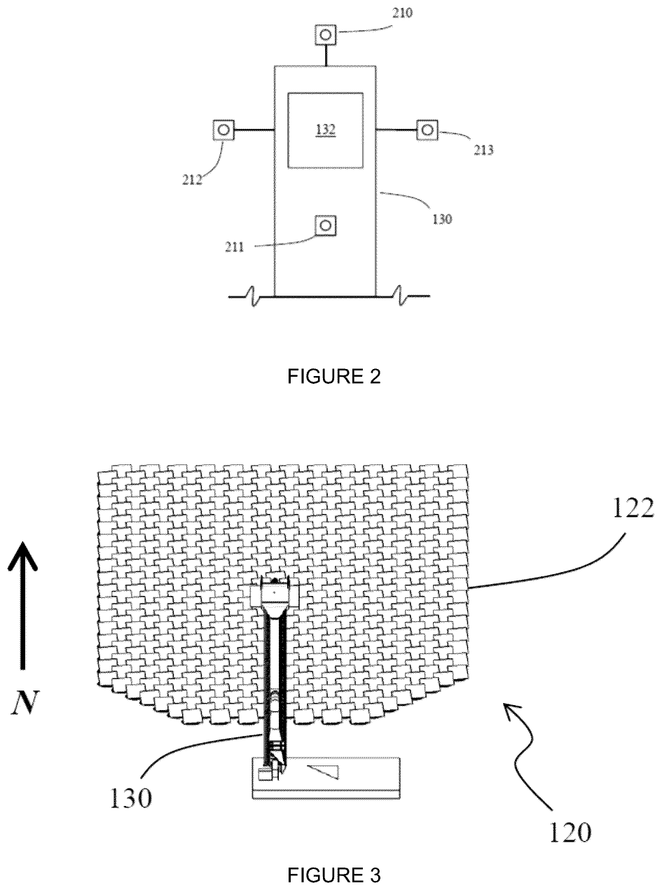

FIG. 2 shows an elevation view of the front side of the receiver 130 and aperture 132 for receiving sunlight into the receiver 130. The receiver 130 may further include absorbers that convert the sunlight to heat and transfer the heat to air, water, molten salt, sand or another working fluid or material. In the illustrated implementation, one or more cameras (e.g., multiple cameras) 210, 211, 212, 213 can be mounted to the receiver 130 (e.g., to the tower 131). In the illustrated example, four cameras 210-213 are shown. However, the system can include more or fewer cameras. Additionally or alternatively, one or more of the cameras can be mounted to other towers or other locations in the heliostat field 120, not the receiver tower 131. The cameras 210, 211, 212, 213 are arranged so that the heliostats 122 of the heliostat array or field 120 are in the field of view of the cameras 210, 211, 212, 213 (e.g., in the field of view of each and every one of the cameras), and so the cameras 210, 211, 212, 213 can capture images of the heliostat mirrors 110 and the reflections therein. In one implementation, the left camera 212 and the right camera 213 are the same distance from the aperture 132. In one implementation, the upper camera 210 and lower camera 211 are the same distance from the aperture 132.

The cameras 210, 211, 212, 213 are installed at known locations (e.g., known geographical locations) and their aim is calibrated by detecting features in the images and solving parameters of an optical model. The cameras 210-213 captured images of the heliostats 122 in the heliostat field 120. The pixels comprising each heliostat 122 in the image, called the heliostat's region of interest (ROI), are used to estimate the normal angle for each heliostat 122. The ROI for each heliostat 122 is calculated using their known geographical (e.g., real-world) location (e.g., due to surveying performed during installation of the heliostats 122) and the location, aim, and intrinsic parameters of the cameras 210-213. Additional corrections to this calculated location for the ROI may be computed based on two dimensional interpolation.

The cameras 210, 211, 212, 213 (e.g., digital cameras with image or optical sensors) may be any of a number of different types of two-dimensional imagers, including still cameras and video cameras. Image data observed in the multiple mirrors 110 (e.g., by the optical or image sensors of the camera(s)) is combined to determine (e.g., using a computer processor) the elevation and azimuth angles of each heliostat mirror 110.

FIG. 3 shows a perspective view of the heliostat array or field 120 and receiver 130. In the illustrated example, the array of heliostats 120 is located in the northern hemisphere, and the heliostats 122 are north of the receiver 130. The cameras 210, 211, 212, 213, although not visible in this figure, have a field of view sufficient to capture a complete image of all of the mirrors 110 of the heliostats 122 in the heliostat array or field 120 (e.g., each camera has a field of view that captured all of the mirrors 110 of the heliostats 122 in the heliostat array or field 120).

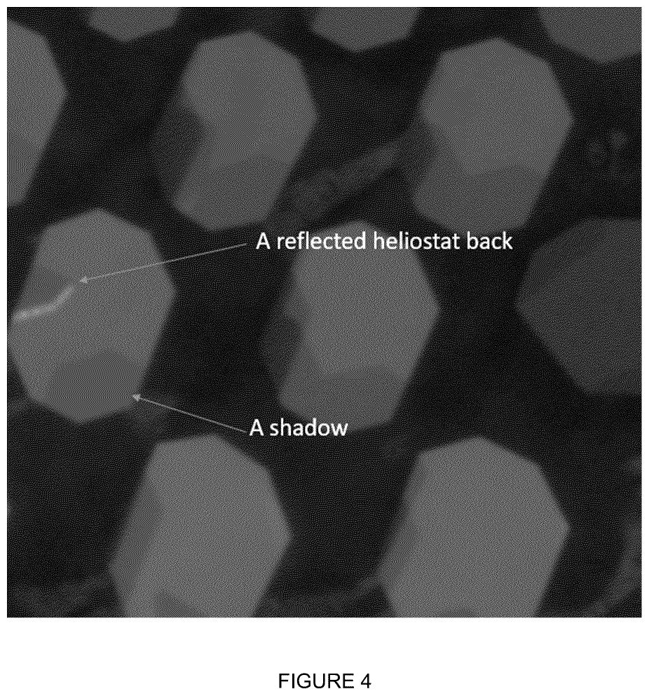

FIG. 4 shows an image captured by one or more of the cameras 210, 211, 212, 213 of heliostats 122 in the heliostat field 120. The captured images of one or more of the heliostats 120 can show shaded portions, which can be due to a reflected portion of a back of a neighboring heliostat or due to a shadow cast on the heliostat 122. This is due to soiling (e.g., dust, dirt) on the heliostat mirror(s) 110. The visibility of the shaded portion of the heliostat mirror 110 varies according to the mix of specular and diffuse reflection, and therefore also varies with the amount of soiling of the heliostat mirror 110 (e.g., the cause of the diffuse reflection). At one end of the spectrum, a “fully soiled” heliostat mirror 110 has a clearly visible shadow from its neighbor. At the other extreme, on a very clean heliostat mirror 110, the shadow is nearly invisible because specular reflected light from the sun is directed away from the camera(s) 210, 211, 212, 213, and the shaded portion of the clean mirror has no dust to direct specular energy towards the camera(s) 210, 211, 212, 213. Soiling on a heliostat mirror 110 can be measured via a correlation between the visibility of a shadow on the heliostat mirror 110 (e.g., the sharpness of edges of the shadow) and an amount of dust corresponding to the clearness of the shadow on the heliostat. For example, a look-up-table can be used by an algorithm to evaluate the level of soiling on heliostat mirrors 110 using images captured of said heliostat mirrors 110 by the camera(s) 210, 211, 212, 213. In one implementation, the algorithm, for example using a look-up table, can provide a quantitative measurement of soling on the heliostat mirror(s) 110. In another implementation, the algorithm, for example using a look-up table, can provide a qualitative measurement of soling on the heliostat mirror(s) 110, for example assigning each heliostat mirror 110 in the captured image with a label designating it's level of soiling, such as “CLEAN” when no shadow is seen in the image for the heliostat mirror 110, “IN NEED OF CLEANING” when the shadow seen in the image for the heliostat mirror 110 exceeds a threshold (e.g., exceeds a degree of sharpness for the edges of the shadow).

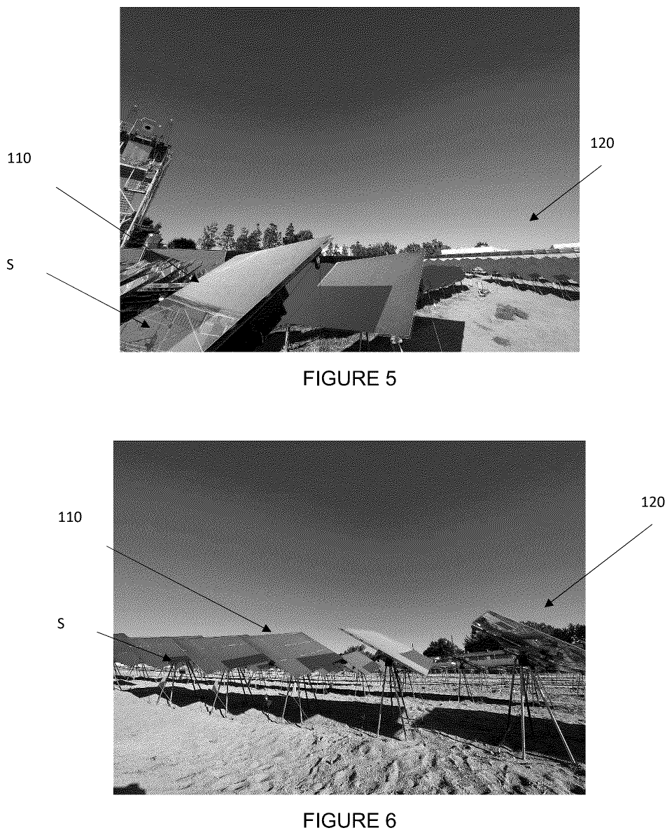

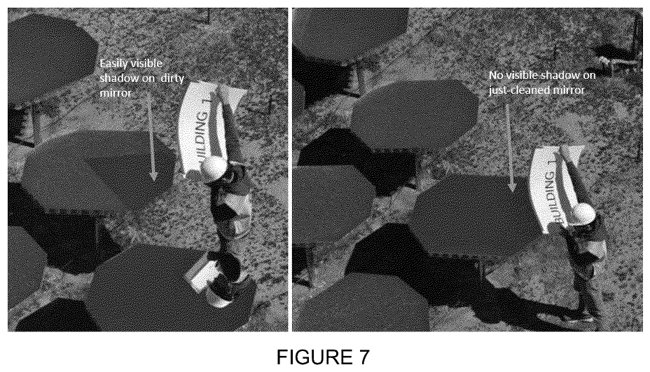

FIGS. 5 and 6 show heliostat mirrors 110 in a heliostat field 120, where one or more of the heliostat mirrors 110 cast a shadow S on neighboring heliostat mirrors 110 due to the dust or soling on such heliostat mirrors 110. FIG. 7 shows two separate heliostat mirrors 110. One heliostat mirror 110 is very clean so no visible shadow is cast on it (e.g., from a neighboring structure, such as a heliostat), and the other heliostat mirror 110 has an amount of soiling on it, resulting in an easily visible shadow on it (e.g., from a neighboring structure, such as a heliostat).

Soiling on a heliostat mirror 110 can reduce the amount of solar flux directed by said mirror 110 to the aperture 132 of the receiver 130 (e.g., due to diffuse reflection caused by soiling, such as dust or dirt particles on the mirror 110) as compared with a clean heliostat mirror 110 (e.g., mirror without soiling). Additionally, the more soiling a heliostat mirror 110 has, the more the amount of the solar flux directed by said mirror to the aperture 130 of the receiver 130 can be reduced, as compared with a clean heliostat mirror 110 (e.g., mirror without soiling). The receiver 130 of the CSP system 1 can be designed to provide a predetermined amount of energy (e.g., as heat) with specular reflection from one or more of the heliostat mirrors 110 (e.g., a first subset of the heliostat field 120) when the heliostat mirrors 110 are clean. However, the amount of energy provided by the same heliostat mirrors 110 (e.g., the first subset of the heliostat field 120) is reduced when they are soiled. Thus, to achieve the same amount of energy as with the heliostats 110 when they are clean, a greater number of heliostat mirrors 110 that those in the first subset would need to be oriented to reflect light toward the aperture 132 of the receiver 130 of the CSP system 1.

One aspect of the disclosure, as discussed further below, is to use visual detection and measurement of soiling on heliostat mirrors 110 to determine the reduction in energy provided by the mirrors 110 (as compared to the same mirrors when they are clean) and/or to determine the additional number of heliostat mirrors 110 needed to be oriented to the receiver 130 to provide the desired amount of energy. Another aspect of the disclosure, as discussed further below, is to use visual detection and measurement of soiling on heliostat mirrors 110 to determine when such mirrors 110 need cleaning (e.g., and to send one or more signals to a maintenance unit to clean the mirrors 110).

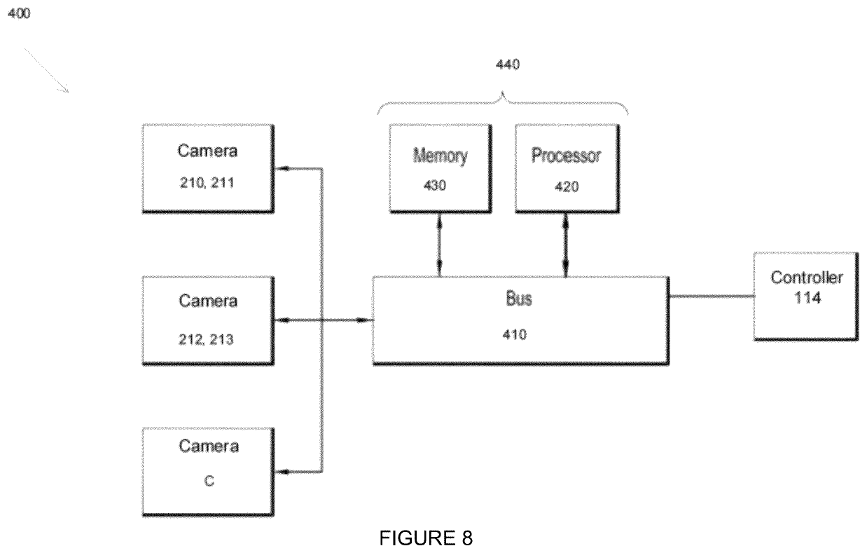

FIG. 8 is a block diagram illustrating a processing system 400 for performing the algorithm. The processing system 400 includes a bus 410 or other communication mechanism for communicating information. The system 400 also includes a processor 420 and memory 430 in communication with the bus 410 and providing a computing unit 440. The processor 420 processes information and executes instructions, such as the algorithm(s) or processes described herein. The memory 430 stores information and instructions to be executed by the processor 420, such as the algorithm(s) or processes discussed herein. The bus 410 receives captured images from the one or more cameras 210, 211, 212, 213, C for use by the processor 420 in processing information and executing instructions, such as the algorithm(s) in the manner described herein. Additionally, once the images are registered, the processing system 400 can provide instructions to the controller(s) 114 of one or more of (e.g., a subset of) the heliostats 122 in the heliostat field or array 120 to maintain or change an orientation (e.g., elevation angle and/or azimuth angle) of the mirror 110 of the heliostat 122 to focus sunlight reflected by the mirror(s) 110 to the aperture 132 of the receiver 130.

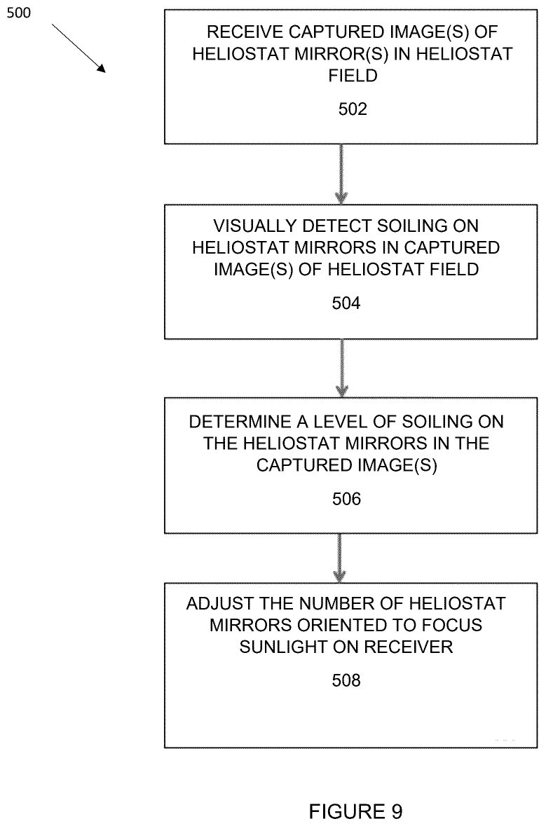

FIG. 9 shows a process or method 500 for the operation of heliostat mirrors in a heliostat field (e.g., such as the heliostat mirrors 110 in the heliostat field 120) based on the visual detection and measurement of soiling on the heliostat mirrors. The process or method 500, which can be carried out by an algorithm, includes the step 502 of receiving an image (e.g., captured image) of one or more heliostat mirrors (e.g., such as heliostat mirrors 110) of a heliostat field (e.g., such as heliostat field 120) from one or more cameras (e.g., such as cameras 210-213). The method 500 also includes the step 504 of visually detecting soling on the heliostat mirror(s) in the captured image. As discussed above, this can be done by identifying shadows on the heliostat mirror(s) in the captured image. The method 500 can also include the step 506 of determining (e.g., measuring) a level of soiling on the heliostat mirror(s) in the captured image. As discussed above, this can be done (for example using a look-up-table) by correlating the image of the shadow (e.g., sharpness of edges of the shadow) on the heliostat mirror(s) in the captured image with a level (e.g., an amount) of soiling on the heliostat mirror(s). The method 500 can also include the step 508 of adjusting the number of heliostat mirror(s) to focus sunlight on the receiver to provide a desired (e.g., predetermined) amount of energy to the receiver. For example, as discussed above, by determining the level of soiling on the heliostat mirror(s), a reduction in the energy output (e.g., of the solar flux output) by the heliostat mirror, as compared with a clean heliostat mirror, can be determined. Such a determination can then be used to determine the number of additional heliostat mirrors that need to be orientated to reflect sunlight to the aperture of the receiver in order to provide the desired (e.g., predetermined) amount of energy to the receiver.

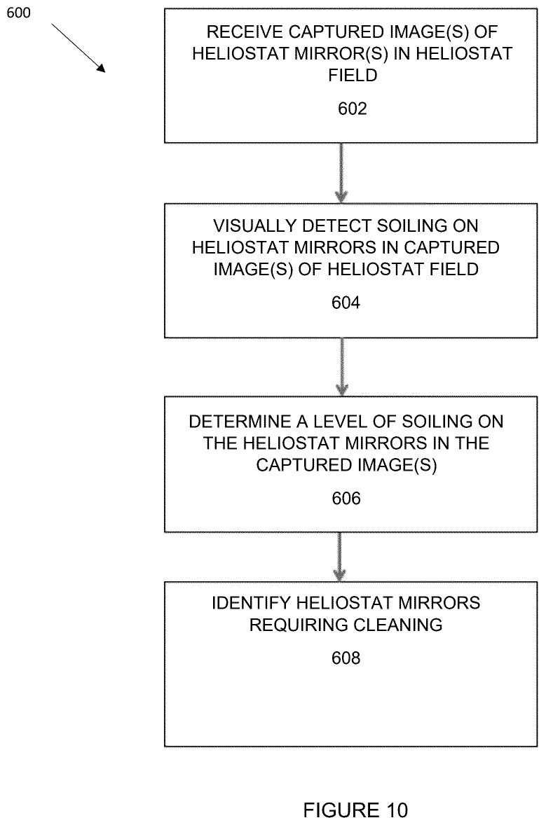

FIG. 10 shows a process or method 600 for identifying heliostat mirrors in a heliostat field that are in need of cleaning based on visual detection and measurement of soiling on the heliostat mirrors. The process or method 600, which can be carried out by an algorithm, includes the step 602 of receiving an image (e.g., captured image) of one or more heliostat mirrors (e.g., such as heliostat mirrors 110) of a heliostat field (e.g., such as heliostat field 120) from one or more cameras (e.g., such as cameras 210-213). The method 600 also includes the step 604 of visually detecting soling on the heliostat mirror(s) in the captured image. As discussed above, this can be done by identifying shadows on the heliostat mirror(s) in the captured image. The method 600 can also include the step 606 of determining (e.g., measuring) a level of soiling on the heliostat mirror(s) in the captured image. As discussed above, this can be done (for example using a look-up-table) by correlating the image of the shadow (e.g., sharpness of edges of the shadow) on the heliostat mirror(s) in the captured image with a level (e.g., an amount) of soiling on the heliostat mirror(s). The method 600 can also include the step 608 of identifying heliostat mirrors requiring cleaning. As discussed above, by determining the level of soiling on heliostat mirrors in the captured image can allow heliostat mirrors with soiling above a threshold amount to identify heliostat mirrors in need of cleaning. Once identified, a maintenance unit can be dispatched or a work order provided for the cleaning of said identified heliostat mirrors. Additionally, the method 600 can include identifying which heliostat mirrors get soiled more quickly, so that they can be cleaned more often, optimizing performance of the CSP system or plant 1 under a given cleaning equipment and operations budget.

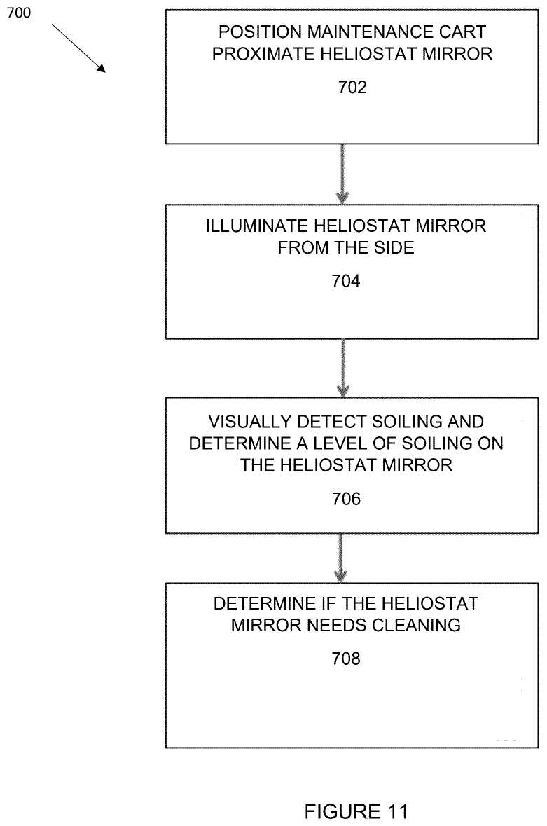

FIG. 11 shows a process or method 700 for identifying heliostat mirrors in a heliostat field that are in need of cleaning based on visual detection and measurement of soiling on the heliostat mirrors. The process or method 700, some steps of which can be carried out by an algorithm, includes the step 702 of positioning a maintenance cart proximate a heliostat mirror (e.g., such as heliostat mirror 110) in a heliostat field (e.g., such as heliostat field 120). The method 700 also includes the step 704 of illuminating the heliostat mirror from the side (e.g., direction light, such as from a flashlight, in a direction parallel to the surface of the heliostat mirror 110). The method 700 also includes the step 706 of visually detecting soling on the heliostat mirror(s). This can be done by identifying dust or dirt particles from said illumination of the heliostat mirror from the side. The method can also include determining (e.g., measuring) a level of soiling on the heliostat mirror(s). The method 700 can also include the step 708 of determining if the heliostat mirror requires cleaning. As discussed above, by determining the level of soiling on heliostat mirrors, the heliostat mirrors with a soiling level above a threshold amount can be identified for cleaning.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A system for operating a heliostat field of a concentrated solar power (CSP) plant, comprising:
one or more cameras arranged relative to the heliostat field so that heliostats in the heliostat field are in a field of view of the one or more cameras, the one or more cameras operable to capture an image of the heliostat field; and
a processor configured to:
receive the captured image,
detect in the captured image one or more soiled heliostat mirrors in the heliostat field; and
determine a level of soiling of said one or more soiled heliostat mirrors in the heliostat field.

2. The system of claim 1, wherein the processor is further configured to determine a reduction in energy output from said one or more soiled heliostat mirrors based on the determined level of soiling of said one or more heliostat mirrors.

3. The system of claim 2, wherein the processor is further configured to determine a number of additional heliostat mirrors required to provide an amount of energy output equal to the reduction in energy output from said one or more soiled heliostat mirrors.

4. The system of claim 3, wherein the processor is further configured to adjust an orientation of the number of additional heliostat mirrors to focus sunlight on the receiver of the CSP plant to provide said amount of energy output to the receiver.

5. The system of claim 1, wherein detecting the one or more soiled heliostat mirrors includes identifying shadows on heliostat mirrors in the captured image.

6. The system of claim 1, wherein determining the level of soiling includes using a look-up table that correlates an image of a shadow on a heliostat mirror in the captured image with a level of soiling.

7. The system of claim 6, wherein correlating the image of the shadow with the level of soiling includes correlating a sharpness of one or more edges of the shadow with the level of soiling.

8. The system of claim 6, wherein the processor is further configured to identify one or more soiled heliostat mirrors in the heliostat field requiring cleaning.

9. The system of claim 8, wherein identifying the one or more soiled heliostat mirrors requiring cleaning includes identifying soiled heliostat mirrors with a level of soiling exceeding a threshold amount of soiling.

10. A method operating a heliostat field of a concentrated solar power (CSP) plant, comprising:
receiving with a computer processor an image of the heliostat field captured by one or more cameras;
detecting with the computer processor one or more soiled heliostat mirrors in the heliostat field from the image captured by the one or more cameras; and
determining with the computer processor a level of soiling of said one or more soiled heliostat mirrors in the heliostat field.

11. The method of claim 10, further comprising determining with the computer processor a reduction in energy output from said one or more soiled heliostat mirrors based on the determined level of soiling of said one or more heliostat mirrors.

12. The method of claim 11, further comprising determining with the computer processor a number of additional heliostat mirrors required to provide an amount of energy output equal to the reduction in energy output from said one or more soiled heliostat mirrors.

13. The method of claim 12, further comprising adjusting with the computer processor an orientation of the number of additional heliostat mirrors to focus sunlight on the receiver of the CSP plant to provide said amount of energy output to the receiver.

14. The method of claim 10, wherein detecting the one or more soiled heliostat mirrors includes identifying shadows on heliostat mirrors in the captured image.

15. The method of claim 10, wherein determining the level of soiling includes using a look-up table that correlates an image of a shadow on a heliostat mirror in the captured image with a level of soiling.

16. The method of claim 15, wherein correlating the image of the shadow with the level of soiling includes correlating a sharpness of one or more edges of the shadow with the level of soiling.

17. The method of claim 16, further comprising identifying with the computer processor one or more soiled heliostat mirrors in the heliostat field requiring cleaning.

18. The method of claim 17, wherein identifying the one or more soiled heliostat mirrors requiring cleaning includes identifying soiled heliostat mirrors with a level of soiling exceeding a threshold amount of soiling.

19. A computer executable code stored in a computer readable memory, that when executed by a computer processor is configured to cause the computer processor to:
receive an image of a heliostat field captured by one or more cameras;
detect one or more soiled heliostat mirrors in the heliostat field from the image captured by the one or more cameras; and
determine a level of soiling of said one or more soiled heliostat mirrors in the heliostat field.

20. The code defined in claim 19, wherein when executed by the computer processor, the computer executable code causes the computer processor to determine a reduction in energy output from said one or more soiled heliostat mirrors based on the determined level of soiling of said one or more heliostat mirrors.

21. The code as defined in claim 20, wherein when executed by the computer processor, the computer executable code causes the computer processor to determine a number of additional heliostat mirrors required to provide an amount of energy output equal to the reduction in energy output from said one or more soiled heliostat mirrors.

22. The code as defined in claim 21, wherein when executed by the computer processor, the computer executable code causes the computer processor to adjust an orientation of the number of additional heliostat mirrors to focus sunlight on a receiver of a concentrated solar power plant to provide said amount of energy output to the receiver.

23. The code as defined in claim 19, when executed by the computer processor, the computer executable code causes the computer processor to detect the one or more soiled heliostat mirrors by identifying shadows on heliostat mirrors in the captured image.

24. The code as defined in claim 19, when executed by the computer processor, the computer executable code causes the computer processor to determine the level of soiling using a look-up table to correlate an image of a shadow on a heliostat mirror in the captured image with a level of soiling.

25. The code as defined in claim 24, when executed by the computer processor, the computer executable code causes the computer processor to correlate the image of the shadow with the level of soiling by correlating a sharpness of one or more edges of the shadow with the level of soiling.

26. The code as defined in claim 19, when executed by the computer processor, the computer executable code causes the computer processor to identify one or more soiled heliostat mirrors in the heliostat field requiring cleaning.

27. The code as defined in claim 26, when executed by the computer processor, the computer executable code causes the computer processor to identify the one or more soiled heliostat mirrors requiring cleaning by identifying soiled heliostat mirrors with a level of soiling exceeding a threshold amount of soiling.
